(19) United States
(12) Patent Application Publication
(10) Pub. No.: US 2010/0125041 A1
(43) Pub. Date: May 20, 2010

(54) METHODS OF TESTING A PLURALITY OF TEST SAMPLES AND SYSTEMS THEREFOR

(76) Inventors: Daniel L. Dermody, Midland, MI (US); J. Keith Harris, Midland, MI (US)

Correspondence Address: The Dow Chemical Company, Intellectual Property Section, P.O. Box 1967, Midland, MI, 48641-1967, US

(21) Appl. No.: 12/617,739

(22) Filed: Nov. 13, 2009

Related U.S. Application Data
(60) Provisional application No. 61/114,488, filed on Nov. 14, 2008.

(51) Int. Cl. C40B 30/00; C40B 60/12

(52) U.S. Cl. 506/7; 506/39

(57) ABSTRACT

The invention is a method and system for testing the physicochemical properties of plurality of test samples in parallel. The method includes providing a test assembly having the plurality of test samples, wherein the plurality of test samples is provided over a plurality of cells in the test assembly. A test fluid, a test object, or both are provided over the plurality of test samples to determine a physicochemical property of the plurality of test samples. The physicochemical property of the plurality of test samples is determined from the displacement of the plurality of test samples.

### CROSS-REFERENCE TO RELATED APPLICATION(S)

This application claims benefit of priority from U.S. Provisional Patent Application No. 61/114,488, filed Nov. 14, 2008, which application is incorporated by reference herein in its entirety.

### FIELD OF INVENTION

The invention relates generally to methods and systems for testing a plurality of test samples in parallel and in particular to methods of testing physicochemical property of the plurality of test samples.

### BACKGROUND

Combinatorial chemistry is a relatively new area of research aimed at rapid synthesis and testing methods to build libraries of polymeric, organic, inorganic or solid state materials. The term “combinatorial chemistry” generally refers to methods and materials for creating collections of diverse materials or compounds commonly known as libraries and to techniques and instruments for evaluating or screening libraries for desirable properties. For example, combinatorial chemistry techniques with the aid of high throughput systems have empowered chemists to rapidly produce large libraries of discrete molecules in the pursuit of discovery of new materials or materials with desirable properties thus reducing the time frame of these discoveries. Consequently, the discovery of new materials with novel chemical and physical properties can depend largely on the ability to analyze the new materials in parallel.

The new materials can have wide ranging applications in industry namely, transportation, housing, personal care, fabric and surface care, agrochemicals and food packaging. Certain applications may require the new material to be formed as films. Some of these applications may require the films to provide resistance to external environment. Certain other applications may require the film to dissolve and/or disintegrate after a period of time. The physicochemical properties of the films such as compatibility with other materials have to be tested for their possible utility in these applications. Some of the currently practiced techniques are ASTM standard testing methods such as ASTM Standard D5402-06 or ASTM D870-02.

ASTM Standard D5402-06, “Standard Practice for Assessing the Solvent Resistance of Organic Coatings Using Solvent Rubs”, ASTM International, West Conshohocken, Pa. involves a solvent rub technique for assessing the solvent resistance of an organic coating that chemically changes during the curing process. The solvent resistance is assessed by visual observation. Moreover, this technique may not be suitable for testing plurality of films in parallel. ASTM D870-02 “Standard Practice for Testing Water Resistance of Coatings Using Water Immersion”, ASTM International, West Conshohocken, Pa. involves testing water resistance of coatings by the partial or complete immersion of coated specimens in distilled or de-mineralized water at ambient or elevated temperatures. The resistance to water is assessed by visual examination and it requires large amounts of water. Therefore, it is desirable to provide improved methods and systems for testing plurality of samples in parallel.

### SUMMARY OF THE INVENTION

According to one embodiment of the invention, a method for testing a plurality of test samples in parallel is provided. The method includes providing a test assembly having the plurality of test samples, wherein the plurality of test samples is provided over a plurality of cells in the test assembly. A test fluid, a test object, or both are provided over the plurality of test samples to determine a physicochemical property of the plurality of test samples. The test fluid may be a test liquid or a test gas but is preferably a liquid. The method further includes monitoring a displacement of the plurality of test samples provided over the plurality of cells by a detection system, wherein monitoring the displacement includes monitoring a displacement of the test sample in contact with the test fluid and/or the test object across the plurality of cells. The physicochemical property of the plurality of test samples is determined from the displacement of the plurality of test samples.

In another embodiment, a system for testing a plurality of test samples in parallel is provided. The system includes a test assembly having the plurality of test samples, wherein the plurality of test samples is provided over a plurality of cells within the test assembly. The system further includes a test fluid, a test object, or both a test fluid and test object over the plurality of test samples to test a physicochemical property of the plurality of test samples. The system further includes a detection system to monitor a displacement of the plurality of test samples provided over the plurality of test samples, wherein the detection system further monitors a displacement of the test sample in contact with the test fluid and/or the test object across the plurality of cells.

### DRAWINGS

These and other features, aspects, and advantages of the present invention will become better understood when the following detailed description is read with reference to the accompanying drawings in which like characters represent like parts throughout the drawings, wherein:

FIGS. 1-3 illustrate fabrication stages of a test assembly, in accordance with embodiments of the present invention;

FIGS. 4-8 illustrate fabrication stages of a test assembly, in accordance with embodiments of the present invention; and

FIG. 9 is a schematic representation of a system for testing a plurality of test samples in parallel, according to embodiments of the present invention.

### DETAILED DESCRIPTION

As used herein, the term “test” refers to relative screening of the plurality of test samples whereby the property of the plurality of test samples is determined relative to each other. In some embodiments, the property of the plurality of test samples can be determined with reference to at least one sample of known property. The term “test” as used herein also refers to determining individual property of each of the plurality of test samples.

A test assembly having the plurality of test samples is provided. In some embodiments, the test assembly forms part of a high throughput system for screening large libraries of materials in parallel. The plurality of test samples is provided over a plurality of cells within the test assembly. In some embodiments, the plurality of test samples is a film. In some embodiments, the plurality of test samples is a multi-layered film having more than one film layer. For example, the plurality of test samples can be a laminate, for use in packaging industry, composed of two film layers attached to each other by means of an adhesive layer. In certain embodiments, each of the plurality of test samples can be of same kind of film. The same kind of film can have similar chemical composition, or mechanical properties such as thickness; or physical properties such as optical properties. As will be appreciated, the plurality of test samples can be composed of inorganic materials, organic materials, polymeric materials or any combinations thereof. In some embodiments, each of the plurality of test samples is composed of water-soluble polymers, bio-degradable polymers, polyvinyl alcohols, latex films, cellulosics, waxes, or even compressed powders. In one example, each of the plurality of test samples is made of polyvinyl chloride (PVC). In certain other embodiments, each of the plurality of test samples can be of different kinds of films. For example, each of the plurality of test samples can be made of a polymeric blend of PVC and polyketone having a composition, wherein a ratio of PVC to polyketone in the composition varies from one test sample to the other. In some embodiments, at least one of the plurality of test samples is composed of a polymeric material and has a coating to enhance a property of the film, for example a barrier property.

Without any limitation, the plurality of test samples can be rigid or flexible. The plurality of test samples can be transparent, translucent or opaque. As used herein, the terms “transparent”, “translucent” or “opaque” refers to the light transmission ability of the plurality of test samples. As used herein, the term “light” refers to electromagnetic radiation in a range of frequencies running from infrared through the ultraviolet, roughly corresponding to a range of wavelengths from about 1 nanometer (10⁻⁹ meters) to about 100 microns (10⁻⁴ meters).

The plurality of test samples can be of any suitable shape and/or size. For example, the shape of the plurality of test samples can be similar to the shape of the plurality of cells. In one example, the plurality of test samples can have a dimension that is about or greater than about an opening of the plurality of cells. In some embodiments, the plurality of test samples can have a thickness in the range of about 0.025 millimeters (mm) to about 5.0 mm in thickness. In one embodiment, the plurality of test samples can have a thickness in the range of about 0.1 mm to about 1.0 mm in thickness.

A test fluid, a test object, or both are provided over the plurality of test samples. In some embodiments, the test fluid is provided by means of automated lines operable to provide the test fluid over the plurality of test samples. In certain embodiments, the test fluid and/or the test object can be provided manually. This step is preferably performed in a parallel manner. For example, one may provide the test fluid and/or the test object in a row by row manner over the plurality of test samples, or by simultaneously providing over all of the plurality of test samples.

In some embodiments, the test fluid can be a gas or liquid but is preferably a liquid such as solvent; slurrie; paste; gel or any combination thereof. Exemplary test liquids include water, hydrocarbon solvents, methanol, ethanol, propanol, methyl ethyl ketones, glycol ethers, mineral oils, hexane, octane and any combinations thereof. In one embodiment, the test liquid is buffered aqueous solution or buffered salt solution or any combinations thereof. In some embodiments, the test fluid provided over the plurality of test samples is of the same kind. In certain embodiments, the test fluid provided over the plurality of test samples is of different kind. In one example, the test liquid is water and the plurality of test samples is a film composed of a water soluble polymer having a composition, wherein the composition varies from one test sample to the other. In addition the test fluids can be mixed during the course of the experiment using standard mechanical agitation methods such as overhead mixing, magnetic mixing, or laboratory plate shakers.

In some embodiments, the test object is a solid of a regular shape or of an irregular shape. In certain embodiments, the test object can be hollow inside having a regular shape or an irregular shape. Exemplary regular shapes include cubes, rods, rectangles, spheres, spirals, and hexagons. Exemplary irregular shapes include distorted regular shapes, for example a distorted cube.

In certain embodiments, a contrast agent can be provided over the plurality of test samples. As will be appreciated, the contrast agent can provide clarity while imaging using an optical detection system. In some embodiments, the contrast agent includes dyes, colorants, pigments or any combinations thereof. In one example the contrast agent is a dye that is soluble in the test liquid. Exemplary dyes include acid dyes, basic dyes, anionic dyes, natural dyes and fluorescent dyes such as rhodamine dyes and fluorescein dyes. It is also possible to envisage the use of contrast agents that may provide improvement for non-optical detection systems.

In some embodiments, testing the plurality of test samples includes determining a physicochemical property of the plurality of test samples. As used herein, the term “physicochemical property” refers to the chemical, physical and/or mechanical properties of the plurality of test samples. In some embodiments, the physicochemical property of the plurality of test samples of the same kind due to contact with test fluids of different kinds can be utilized for screening the plurality of test fluids and/or the test samples. The physicochemical property of the test samples can be measured as a function of time and/or temperature. In one embodiment, the plurality of test samples can be made to contact the test liquid for a period of time and the physicochemical property of the plurality of test samples over a period of time after removal of the test liquid can be monitored to determine the physicochemical property. Exemplary physicochemical property includes deformation, compatibility, dissolution, stretchability, elongation, dissolution and/or rupture of the plurality of test samples in contact with the test fluid and/or the test object. In one embodiment, the stretchability of the plurality of test samples due to contact with the test liquid is determined by applying a pressure on the plurality of test samples. In one embodiment, such pressure is exerted by means of the test object.

A displacement of the plurality of test samples is monitored. In some embodiments, monitoring the displacement of the plurality of test samples includes monitoring the displacement of the plurality of test samples across the plurality of cells using a detection system. The term “displacement” as used herein refers to the change in position of a part or whole of the plurality of test samples. In some embodiments, monitoring the displacement of the plurality of test samples includes monitoring the displacement of the test fluid and/or the test object provided over the plurality of test samples.

In one embodiment, the detection system includes a pressure sensing device, a pressure transducer, an optical detection system, an optical scanner, a video camera or any combinations thereof. As will be appreciated, the pressure sensing device can be provided adjoining the plurality of test samples and is operable to monitor the displacement of the plurality of test samples provided over the plurality of cells. In some embodiments, a pressure transducer can be used to monitor the displacement. The pressure transducer can be connected to a pressure line in communication with the plurality of cells below each of the plurality of test samples. The test fluid can be provided over the plurality of test samples. In one embodiment, an initial pressure can be provided by introducing a gas in the plurality of cells and the pressure can be monitored by the pressure transducer. In one example, the pressure transducer may record a lowering of pressure from the initial pressure when the test sample is ruptured. In one embodiment, the pressure transducer may record a lower pressure for a test sample that is ruptured when compared to a test sample that is not ruptured.

In one embodiment, a stretchable membrane can be fitted above each of the plurality of test samples. A gas can be injected in a space between the membrane and the plurality of test samples to form a bubble out of the membrane over the plurality of test samples. A displacement of the membrane, due to displacement of the plurality of test samples in contact with the test fluid and/or the test object can be monitored. For example, dissolution of the plurality of test samples may rupture the membranes which can be monitored by an optical detection system. In some embodiments, the pressure sensing device can be used to monitor the displacement of the membrane.

In one embodiment, the optical detection system can be provided adjacent to the plurality of test samples. In another embodiment, the optical detection system can be provided along a base of the test assembly. In yet another embodiment, the optical detection system can be provided along a side wall of the test assembly to monitor the displacement of the plurality of test samples.

The physicochemical property of the plurality of test samples is determined from the displacement of the plurality of test samples. In one embodiment, the detection system is operable to determine the physicochemical property as a function of time. For example, the plurality of test samples can be tested by monitoring the displacement of the plurality of test samples over time and from the displacement over time, the physicochemical property of each of the plurality of test samples can be determined. In some embodiments, the detection system is operable to determine the physicochemical property as a function of time, or temperature or both.

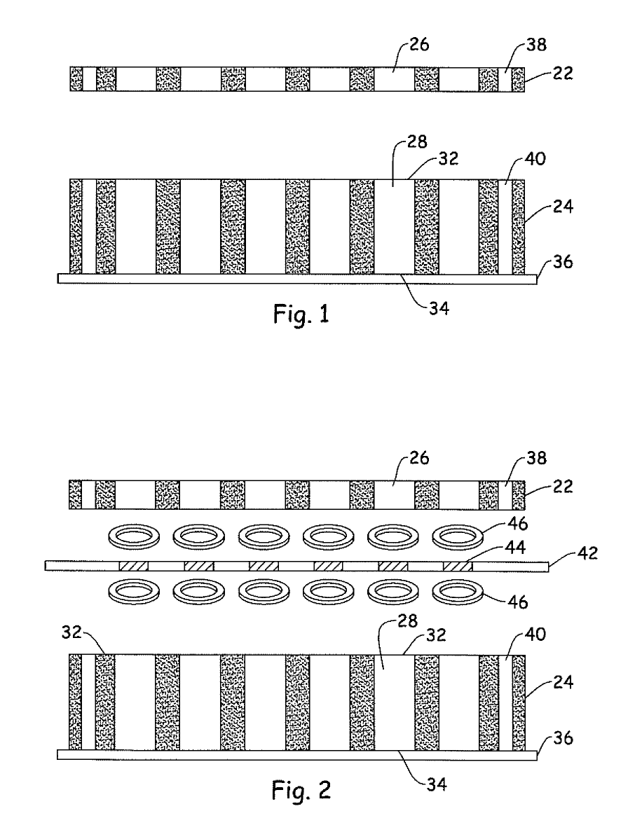

FIGS. 1-3 illustrate fabrication stages of a test assembly, in accordance with embodiments of the present invention. A first template 22 and a second template 24 are provided, in FIG. 1. The first template 22 includes a first plurality of openings 26 spaced apart from each other and extending through the first template 22. The first plurality of openings 26 can be in a single row in the first template 22. In some embodiments, the first template 22 can be a two-dimensional array having plurality of rows of the first plurality of openings 26. A plurality of cells 28 is provided in the second template 24. The plurality of cells 28 are aligned with the first plurality of openings 26 of the first template 22. In some embodiments, the plurality of cells 28 can be plurality of wells and forms part of the second template 24. In certain embodiments, the plurality of cells 28 can be plurality of vials that are removable and are placed in the second template 24. The plurality of cells 28 has an opening 32 and a base 34. In some embodiments, the base 34 of the plurality of cells 28 is transparent. In certain embodiments, the plurality of cells 28 and the second template 24 are transparent. In FIG. 1, the second template has a base 36 for holding the plurality of cells 28. In some embodiments, the first template 22 and the second template 24 include grooves 38 and 40, respectively for attaching each other, as discussed later.

A test substrate 42 is provided between the first template 22 and the second template 24, in FIG. 2. The test substrate 42 is a film, in some embodiments. The test substrate 42 can be a continuous film or a discontinuous film. The discontinuous film can be cut-outs of the continuous film placed over and aligned with the openings of the plurality of cells 28 of the second template 24. In some embodiments, the test substrate 42 is of same kind of film having similar chemical composition, or mechanical properties such as thickness; or physical properties such as optical properties. In certain embodiments, the test substrate 42 is of different kinds of films having differing chemical composition, or mechanical properties such as thickness; or physical properties such as optical properties. In the illustrated embodiment of FIG. 2, the test substrate 42 is a continuous film. The test substrate 42 forms the plurality of test samples 44, corresponding to, and aligned with the first plurality of openings 26 of the first template 22 and the plurality of cells 28 of the second template 24.

A sealing element 46 is provided above and/or below the plurality of test samples 44 and between the first template 22 and the second template 24. As will be appreciated, the sealing element 46 may hold the plurality of test samples 44 in place and may advantageously minimize cross-contamination between the plurality of test samples 44. In the illustrated embodiment of FIG. 2 the sealing element 46 is an O-ring.

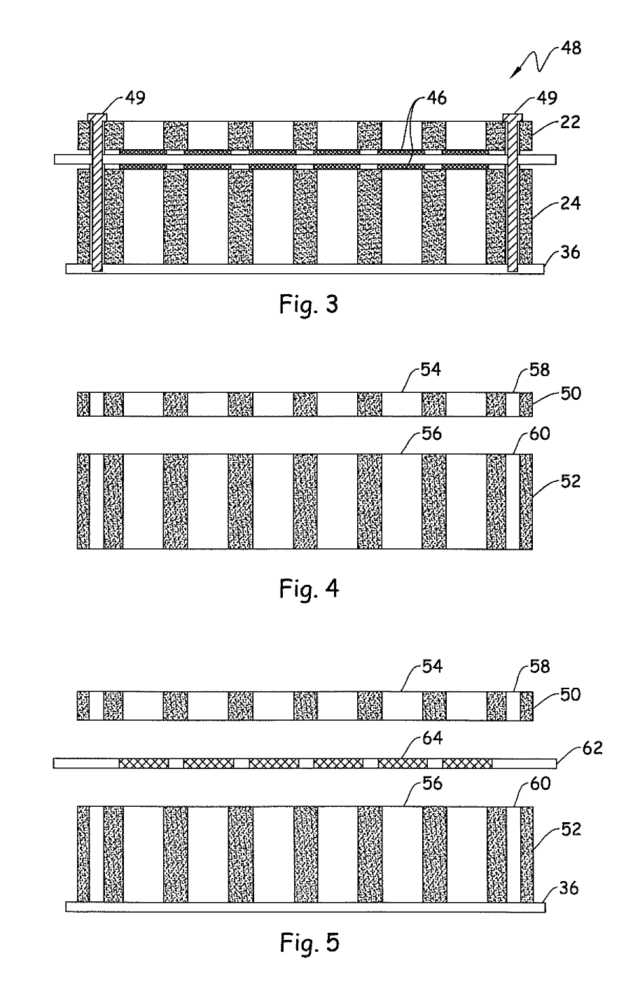

The first template 22 and the second template 24 are attached to form the test assembly 48, in FIG. 3. In one embodiment, the attaching is by mechanical means such as by utilizing a fastener 49 through the grooves 38 and 40 of the first template 22 and the second template 24, respectively. In some embodiments, the first template 22 and the second template 24 can be attached by means of an adhesive.

FIGS. 4-8 illustrate fabrication stages of another test assembly, in accordance with embodiments of the present invention. A first template 50 and a second template 52 are provided, in FIG. 4. The first template 50 can be similar to the first template 22 of FIGS. 1-3. The first template 50 includes a first plurality of openings 54. A second plurality of openings 56 is provided in the second template 52. The second plurality of openings 56 is aligned with the first plurality of openings 26 of the first template 50. The second plurality of openings 56 can be in a single row in the second template 52. In some embodiments, the second template 52 can be a two-dimensional array having plurality of rows of the second plurality of openings 56. In some embodiments, the first template 50 and the second template 52 include grooves 58 and 60, respectively for attaching to each other.

A test substrate 62 is provided between the first template 50 and the second template 52, in FIG. 5. The test substrate 62 can be similar to the test substrate 42 of FIGS. 2-3. The test substrate 62 forms the plurality of test samples 64, corresponding to, and aligned with the first plurality of openings 54 of the first template 50 and the second plurality of openings 56 of the second template 52.

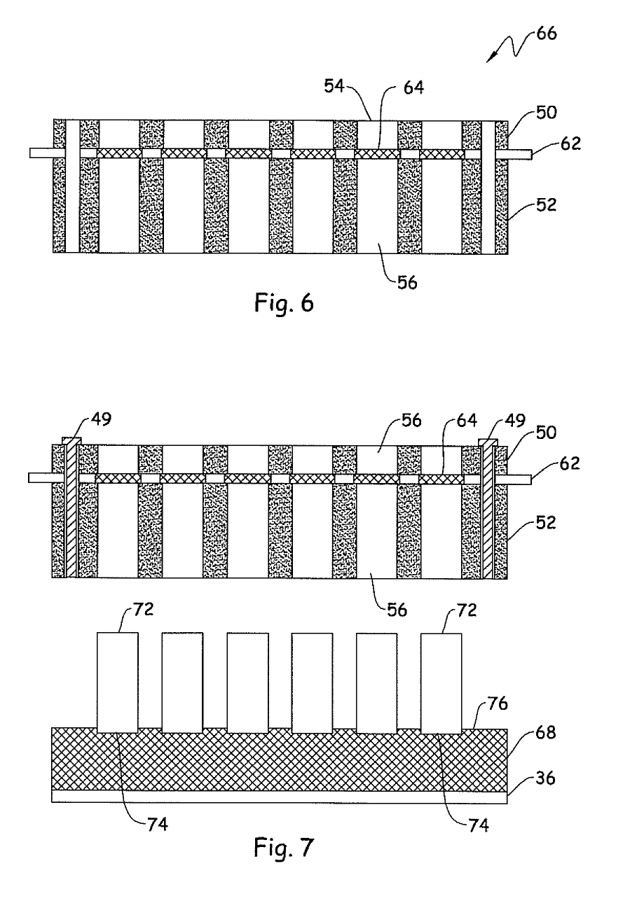

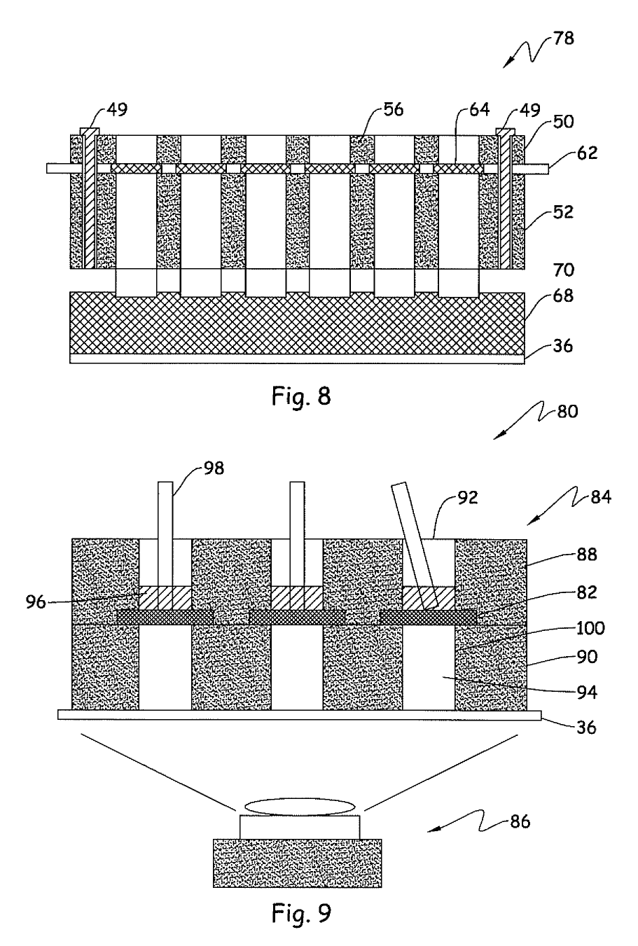

The first template 50 and the second template 52 are attached to form a substrate holder 66, in FIG. 6. A third template 68 having a plurality of cells 70 is provided in FIG. 7. The plurality of cells 70 can be similar to the plurality of cells 28 of FIGS. 1-3. The plurality of cells 70 has an opening 72 and a base 74. The base 74 of the plurality of cells 70 can be transparent. In the illustrated embodiment of FIG. 7, the plurality of cells 70 extends above an upper surface 76 of the third template 68. The substrate holder 66 is provided over the third template 68, in FIG. 8. The plurality of test samples 64 are provided over, and aligned with the opening 72 of the plurality of cells 70 of the third template 68 to form a test assembly 78. In some embodiments, the substrate holder 66 is placed over the third template 68 to form the test assembly 78. In certain embodiments, the substrate holder 66 is attached to the third template 68 to form the test assembly 78.

FIG. 9 is a schematic representation of a system 80 for testing a plurality of test samples 82 in parallel, according to embodiments of the present invention. The system 80 includes a test assembly 84 and an optical detection system 86.

The test assembly can be fabricated using methods as described previously with reference to FIGS. 1-8. The test assembly 84 can include a first template 88 and a second template 90. The first template 88 has a first plurality of openings 92 spaced apart from each other and extending through the first template 88. The second template 90 includes a plurality of cells 94 over which the plurality of test samples 82 are provided. A test liquid 96 and a test object 98 are provided over the plurality of test samples 82. In the illustrated embodiment, the test object 98 is a rod.

In FIG. 9, the optical detection system 86 is provided below the test assembly 84. However, the optical detection system 86 can be provided along a side wall 100 of the plurality of cells 34. The optical detection system 86 can monitor a displacement of the plurality of test samples 82 upon contact with the test liquid 96 and/or the test object 98. In one embodiment, the optical detection system 86 is operable to simultaneously test all of the plurality of test samples 82. In certain embodiments, the optical detection system 26 can test the plurality of test samples 82 in a row by row manner.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of testing a plurality of test samples in parallel comprising:
providing a test assembly comprising the plurality of test samples, wherein the plurality of test samples is provided over a plurality of cells in the test assembly;
providing a test fluid, a test object or both a test fluid and a test object over the plurality of test samples to determine a physicochemical property of the plurality of test samples;
monitoring a displacement of the plurality of test samples provided over the plurality of cells by a detection system; and
determining the physicochemical property of the plurality of test samples from the displacement of the plurality of test samples.

2. The method of claim 1 wherein the test fluid is a liquid.

3. The method of claim 1, wherein providing the test assembly comprises forming the test assembly comprising:
providing a first template comprising a first plurality of openings extending therethrough;
providing a second template comprising a plurality of cells, wherein the plurality of cells are aligned with the first plurality of openings;
providing a test substrate between the first template and the second template to form the plurality of test samples corresponding to, and aligned with the first plurality of openings and the plurality of cells and provided over the plurality of cells; and
attaching the first template and the second template to form the test assembly, wherein the test substrate is held between the first template and the second template.

4. The method of claim 3, wherein
attaching the first template and the second template to form a substrate holder, wherein the test substrate is held between the first template and the second template in the substrate holder;
providing a fourth template comprising the plurality of cells; and
placing the substrate holder over the fourth template to form the test assembly, wherein the plurality of test samples are aligned with and positioned over the plurality of cells.

5. The method of claim 3, wherein providing the test substrate further comprises providing at least one sealing element about the plurality of test samples and between the first template and the second template, or about the plurality of test samples and between the first template and the third template.

6. The method of claim 3, wherein the test substrate comprises a continuous film, or a discontinuous film.

7. The method of claim 1 wherein the test substrate is of same kind of film, or wherein the test substrate is of different kinds of films.

8. The method of claim 2, wherein providing the test liquid comprises providing a solvent, or providing a slurry, or providing a gel, or providing a paste, or any combinations thereof.

9. The method of claim 2, wherein providing the test liquid comprises providing test liquid of same kind, or providing test liquids of different kinds.

10. The method of claim 1, wherein providing the test object comprises providing a solid of a regular shape or providing a solid of an irregular shape.

11. The method of claim 1 further comprising providing a contrast agent over the plurality of test samples.

12. The method of claim 1, wherein the test fluid is provided and determining the physicochemical property comprises determining dissolution of the plurality of test samples.

13. The method of claim 1, wherein determining the physicochemical property comprises determining deformation of the plurality of test samples.

14. The method of claim 1, wherein the detection system comprises a pressure sensing device or an optical detection system or both.

15. The method of claim 1, wherein monitoring the displacement of the plurality of test samples comprises monitoring a displacement of the test liquid and optionally the test object.

16. A system for testing a plurality of test samples in parallel comprising:
a test assembly comprising the plurality of test samples, wherein the plurality of test samples is provided over a plurality of cells within the test assembly;
a test fluid, a test object or both a test fluid and a test object over the plurality of test samples to test a physicochemical property of the plurality of test samples; and
a detection system to monitor a displacement of the plurality of test samples provided over the plurality of cells.

17. The system of claim 16, wherein the test assembly comprises:
a first template comprising a first plurality of openings extending therethrough;
a second template comprising a plurality of cells aligned with the first plurality of openings; and
a test substrate held between the first template and the second template to form the test assembly, wherein the test substrate forms the plurality of test samples corresponding to, and aligned with the first plurality of openings and the plurality of cells, and provided over the plurality of cells.

18. The system of claim 16, wherein the test assembly comprises:
a first template comprising a first plurality of openings extending therethrough;
a third template comprising a second plurality of openings extending therethrough, wherein the second plurality of openings are aligned with the first plurality of openings;
a test substrate held between the first template and the third template to form a substrate holder, wherein the test substrate forms the plurality of test samples corresponding to, and aligned with the first plurality of openings and the second plurality of openings; and
a fourth template comprising the plurality of cells, wherein the substrate holder is provided over the fourth template such that the plurality of test samples are aligned with and positioned over the plurality of cells to form the test assembly.

19. The system of claim 16, wherein the detection system comprises scanners, video imaging systems, pressure sensing devices, pressure transducers or any combinations thereof.

20. The system of claim 18 wherein at least one of the third template, the fourth template and the plurality of cells is transparent.
